(19) United States
(12) Patent Application Publication
(10) Pub. No.: US 2007/0144382 A1
(43) Pub. Date: Jun. 28, 2007

(54) Lightened offset plates, preparation and use thereof

(76) Inventor: Jean-Marie Nouel, Villiers sous Grez (FR)

Correspondence Address: DENNISON, SCHULTZ & MACDONALD, 1727 KING STREET, SUITE 105, ALEXANDRIA, VA, 22314, US

(21) Appl. No.: 10/598,032

(22) PCT Filed: Mar. 2, 2005
(86) PCT No.: PCT/FR05/00492

§ 371 Date: Aug. 16, 2006

(30) Foreign Application Priority Data
Apr. 15, 2004 (FR) 0403943
Mar. 3, 2004 (FR) 0402174

(51) Int. Cl. B41N 1/00

(52) U.S. Cl. 101/395

(57) ABSTRACT

The present invention concerns: plates for use in wet offset printing, which have been lightened in an original manner; the preparation of said plates; and their use in the context of wet offset printing. In characteristic manner, said plates comprise two groups of small non ink-accepting lightening surfaces in at least part of their lightened ink-accepting surfaces.

The present invention relates to wet offset printing and more precisely it provides:
plates used for wet offset printing, comprising on their surfaces ink-accepting surfaces corresponding to patterns to be printed; at least part of said ink-accepting surfaces being lightened (i.e. including small lightening non ink-accepting surfaces) in an original manner;
preparing said plates;
their use in the context of wet offset printing.

The use of the plates of the invention is of particular advantage since it ensures that the ink-water mixture (the basis of the wet offset process) is homogeneous at the surface of said plates, regardless of the exact context of that use, namely: the nature of the substrate to be printed, the ink, the printing press, the screen used, or the size and distribution of the ink-accepting surfaces over the plate. Said plates ensure excellent print quality thereby. Their use also brings about better productivity, a general reduction in consumption (ink, substrate to be printed, plate, etc.) and facilitates drying of the deposited ink.

The wet offset printing process uses supports (plates) at the surface of which ink-accepting and hydrophobic surfaces have been generated which correspond to the patterns to be printed and which take up the ink and transfer it, and non ink-accepting and ink repellent surfaces to repel the ink.

On a printing press, the plate is initially wetted by wetting rollers (unless a “fluid ink” constituted by an ink/water mixture is used) and then inked by inking rollers. Said inking rollers deposit the ink onto the ink-accepting surfaces. At this juncture, the ink is always mixed with water which has already been deposited using the wetting rollers or is present due to its constitution (fluid ink). A blanket—fabric or metal coated with a rubbery substance—then takes the ink from said ink-accepting surfaces and deposits it on the substrate to be printed, for example of the paper, board or metal type.

Printing is carried out in one or more colors (usually with yellow, magenta, cyan, and/or black inks) on sheet-fed or web type printing presses.

Regardless of the printing technique in question, the use of ink, and more particularly the drying of ink, remains to be optimized.

Inks are principally constituted by pigments, oils and additives. Regarding their consistency, there are principally three types of ink which, on printing, are intended to generate homogeneous and balanced ink-water mixtures which are distributed over the ink-accepting surfaces of the plate (such mixtures are termed homogeneous or balanced if they have the same quantity of water over all of the ink-accepting surfaces of the plate, regardless of the size and distribution of said surfaces) and thus can provide quality prints without any particular difficulties. The following are known:
hard inks, which are concentrated and usually glossy, and/or strong (HT), which can be applied thinly;
inks known as “soft” inks, which are more fluid and less concentrated in pigments than said hard inks, generally applied more thickly to board, matt paper for books, or newsprint type substrates.

A particular type of “soft” ink is fluid ink. As indicated above, this is a pre-constituted ink/water mixture. Said inks generally comprise about 80% ink and 20% water. They are deposited directly onto the ink-accepting surfaces of the plates without prior wetting. Using them has its advantages. Since the prior wetting step is dispensed with, printing is simplified, with run times and paper consumption being reduced. Fluid inks are generally used on matt paper, in particular when printing text. Their use is generally limited to such contexts as unfortunately, such inks are also unavoidably deposited on the hydrophilic surfaces of the plate;
conventional inks, which constitute a compromise between hard inks and soft inks.

The thickness of the ink to be deposited, generally in the range 0.5 μm [micrometer] to 5 μm, principally depends on the nature of the substrate onto which it is deposited and the type of pattern to be printed.

The ink/water mixtures to be produced on the plate surface during printing generally include 4% to 30% by weight of water, usually 12% to 18% by weight of water. They must be as balanced as possible, regardless of the size and distribution of the ink-accepting surfaces of said plates. With hard and conventional inks which repel water to a greater or lesser extent, the ink-accepting surfaces repel said water which accumulates on the other surfaces of the plates; with the inks denoted “soft” inks, which tend to be mixed with too much water, emulsification of said inks is observed. Mastering the ink/water mixture at the plate surface during printing is a real technical problem that is often one of a printer's main concerns.

Drying said inks is a difficult and/or expensive operation to carry out.

There are currently four principal drying techniques. They are familiar to the skilled person. They are adapted to the nature of the inks in question:
drying, by penetration into the inked support, for “cold-set” inks;
drying by evaporation for “heat-set” inks;
drying by UV radiation for UV inks; and
drying by oxido-polymerization for “sheet-fed” inks.

Reproduction is carried out between two values, namely the “zero” value, i.e. the virgin color of the substrate to be printed, and the “maximum” value, i.e. the full tone produced with the ink employed. To render halftones, screens are used:
principally, conventional screens, with amplitude modulation: these can produce full tone surfaces more or less important depending on whether the intermediate tones are closer to the full tone or to the color of the substrate. Depending on the printing process employed, the nature of the substrate to be printed and the documents to be printed, screens of various grades are used, such as 300, 200, 175, 150, 133, 120, 100, 80 or 65, the number indicating the number of lines to the inch, or screen ruling. The dots are distributed in accordance with said screen rulings and have different areas depending on the values to be printed. Their centers are also equidistant regardless of their area. To avoid a moiré effect between colors, the screen ruling of each color is disposed at a different angle, for example 45° for magenta, 15° for cyan, 75° for black and 90° for yellow;
more rarely, stochastic screens or frequency modulation screens said screens are constituted by small dots of the same area distributed in a more or less random manner. The various values are represented by a different dot density. The area of the dots of a screen is selected as a function of the quality of the substrate to be printed, the printing process and the ink used. Dots of 112 μm² [square micrometers] to more than 1344 μm² are recommended for matt paper and/or cheap paper (newsprint, for example). Agglomerates often appear due to coalescence of said dots.

Screens termed hybrid screens have also been proposed, composed of a stochastic screen for very light and very dark tones and a conventional screen for other tones.

In general, the screen dots are square or more or less rounded and/or square, produced by a set of pixels.

In the context outlined above, the Applicant has demonstrated the advantage of lightening the print, i.e. creating small non ink-accepting surfaces in the ink-accepting surfaces (small non ink-accepting surfaces which obstruct and clear during printing, so that they are effective and improve said printing). The lightening principle has been described in French patent application FR-A-2 660 245; an improvement has been described in European patent application EP-A-0 770 228. According to that improvement, the small non ink-accepting lightening surfaces are distributed in a random manner using a (several) stochastic screen(s). It is recommended that said small lightening surfaces be used in an amount of 2% to 26%, preferably 8% to 14%, of the ink-accepting (thereby lightened) surfaces and with a surface area of about 400 μm². However, such small non ink-accepting surfaces can be envisaged with a much smaller surface area (196 μm² for a very fine paper, for example) or with a greater surface area (1600 μm² for a coarse newsprint type paper, for example).

The use of such small non ink-accepting lightening surfaces can procure a number of advantages which are listed in the text of said European patent application EP-A-0 770 228, especially better homogeneity of the ink/water mixture. It has transpired, however, that such advantages only accrue in certain limited circumstances:
the area of the small surfaces must not be too small since said small surfaces are obstructed and remain obstructed with ink during printing and thus are ineffective. They also cannot be too large, as then said small surfaces are visible on the printed support;
the number of said small surfaces must not be too low to prevent the anticipated improvements from becoming manifest, nor too high to affect reproduction of the patterns or to weaken the ink-accepting surfaces too much or to render wetting regulation too difficult.

Tests have confirmed that, to boost lightening further without affecting printing, the removed ink-accepting area cannot be increased by using a very large number of small non ink-accepting surfaces with an area which is less than the area of the small surfaces which are normally used and which have proven effective. The results are disappointing, as regardless of the paper, the screen, the ink, the press used and the size and distribution of the ink-accepting surfaces on the plate, said small surfaces remain obstructed to a greater or lesser extent throughout printing.

An original type of lightening is proposed in the present invention which can lighten further without disadvantage, and indeed with certain advantages both as regards the quality of the print and carrying out the printing (homogeneity of ink-water mixture, quantities of ink and paper used, ink drying, etc). In the present invention, lightening is enhanced by using two types of small non ink-accepting surfaces, by causing two types of small non ink-accepting surfaces to collaborate: small non ink-accepting surfaces which are effective per se and also small non ink-accepting surfaces which are effective due to the presence of said small non ink-accepting surfaces which are effective per se.

In a first aspect, the present invention concerns plates for use in wet offset printing, comprising on their surface ink-accepting surfaces corresponding to the patterns to be printed, at least part of said ink-accepting surfaces being lightened; i.e. comprising small non ink-accepting lightening surfaces. It concerns plates which are lightened as defined in prior art documents: FR-A-2 660 245 and/or EP-A-0 770 228; positive or negative plates, ready for use, at least some of the ink-accepting surfaces of which are riddled with thousands of small non ink-accepting lightening surfaces. Thus, it is possible for all of the ink-accepting surfaces to be lightened, or only part thereof.

In characteristic manner, on plates of this type, in accordance with the invention, in at least some of the lightened ink-accepting surfaces, and advantageously in all of said lightened ink-accepting surfaces, there are at least two groups of small non ink-accepting lightening surfaces:
a first group of small non ink-accepting surfaces with an area (areas) sufficient to be effective per se and in a quantity sufficient to lighten the ink-accepting surface(s) involved in the lightening by at least 4%; and
a second group of small non ink-accepting surfaces, not effective per se because their area(s) is (are) too small; the mean area of said small non ink-accepting surfaces of said second group in general being less than ⅔ of the mean area of said small non ink-accepting surfaces of said first group;
   said small non ink-accepting surfaces of said first and second groups being distributed so as to minimize, and advantageously avoid any moiré effects.

The lightened ink-accepting surfaces of the plates of the invention may be lightened partly in accordance with the original nature of the invention and partly in conventional manner as defined in FR-A-2660 245 and/or EP-A-0 770 228. They are advantageously entirely lightened in accordance with the invention: they include small non ink-accepting surfaces of the first group and small non ink-accepting surfaces of the second group, whereupon the (lightening) effect is cumulative.

In the first analysis, the small non ink-accepting surfaces of the first and second groups constitute lightening surfaces as defined in the prior art. Their joint presence constitutes the key point of the present invention.

With the aim of minimizing or avoiding any moiré effects, it is recommended that said small lightening surfaces are used, distributed as follows:
either in a random manner, using stochastic screens
or in a conventional manner, using conventional screens (560 μm2 white dot, close to 98%-150 screen, for example) but in this case by distributing them in the orientation used for the screen for the color to be printed. The skilled person is aware that the screen rulings of conventional screens are oriented at different angles for each color (see above).

In the invention, small lightening surfaces may be employed on the surface of a single plate, using different types of distribution (stochastic or conventional screens), this for example depending on the nature of the small surfaces in question (from the first or second group) and/or the zones of said plate in question.

In the context of printing (patterns) with a stochastic screen, the small lightening surfaces of the first and second groups are advantageously (as regards the problem with moiré effects) distributed in accordance with a (several) conventional screen(s). They are advantageously (still referring to the problems with moiré effects) orientated, for each color, in the orientation normally used for printing that color.

The small non ink-accepting surfaces of the first group are effective per se because of their area. They are furthermore effective because employed in a minimal effective quantity, and because they probably influence the ink/water mixture during printing, in that they render effective the small non ink-accepting surfaces of the second group, which are smaller.

Regarding the area of said small non ink-accepting surfaces of said first group, it should initially be noted that the area is not necessarily the same for all of said small non ink-accepting surfaces of said first group. In an advantageous variation, all of said small surfaces have the same area, but this constitutes just one variation. It is possible to find, on a plate of the invention, small non ink-accepting surfaces which are effective perse, with different areas. In any case, the area(s) in question is (are) sufficient to genuinely lighten printing (without systematically obstructing said small surfaces during use of the plate), but they clearly are of a reasonable size which does not affect printing too greatly.

The skilled person will completely understand this notion of effective non-excessive lightening which depends on a number of parameters in the process in question. In the present invention, in a manner which is in no way limiting, it is recommended that:
when printing patterns with an amplitude modulation screen, the area(s) of said small non ink-accepting surfaces of said first group remains (remain) smaller than the 95% white dot value, and advantageously smaller than the 98% white dot value of said screen; or
when printing patterns with a stochastic screen, the area(s) of said small non ink-accepting surfaces of said first group is (are) always less than three times the area of the dot of said screen, and generally in the range 0.5 times to 2 times said area.

When printing patterns with an amplitude modulation screen, the area(s) of said small non ink-accepting surfaces of said first group is (are) advantageously less than the area of the dots of the screen, in the range 95% to 99.5%, advantageously in the range 98% to 99.5% of the screen used. Thus, for a frequently used screen such as the 150 screen, it is recommended that such small non ink-accepting surfaces are of a size in the range 336 μm² to 672 μm² (respectively about 99.5% to 97.7% of the sizes of the white dots of the screens), preferably 448 μm² (about 98.5% of the size of the white dotes of the screens). Assuming that all of the 98% white dots of said small non ink-accepting surfaces would be found on 2% of the ink-accepting dots of the patterns, said 2% value would be reduced by x%, x representing the percentage lightening employed, for example 10% (for a percentage lightening of 10%, said value of 2% would become 2-0.2=1.98%, which would be practically invisible on the printed substrate). The skilled person also knows that the phenomenon of dot gain tends to render white dots with any reasonable lightening invisible on the printed substrate.

Stochastic screens with frequency modulation are currently infrequently used. The skilled person would recognize the advantages (absence of rosette, very rare moiré effects between colors, excellent reproduction of various values) and the disadvantages (difficulties in regulating wetting and inking). Generally and in the context of the invention, in order to avoid too great a reduction in the light values on printing, it is possible to compensate for or only use small non ink-accepting lightening surfaces for the dark values. It is with reference to this selective lightening that lightening dots may be provided which are larger than the dots of the screen employed, or smaller in the light values.

In any case, in the context of printing patterns with a frequency modulated stochastic screen, if they are produced from a conventional screen, the small non ink-accepting lightening surfaces of the two groups are advantageously disposed using orientated screen rulings for the various colors.

In any event, the skilled person can optimize the area(s) of the small non ink-accepting lightening surfaces of the first group.

Said small surfaces present in the lightened ink-accepting surface(s) ensure a percentage lightening of at least 4%. It should be understood that the percentage lightening, in this case 4%, represents the ratio between the removed area (the sum of the areas of all of said small non ink-accepting surfaces) and the area of the ink-accepting surface(s) from which it is removed. This percentage lightening by the small surfaces of the first group is generally in the range 4% to 20%, advantageously in the range 6% to 12%. It should be sufficient (>4%) to render the small non ink-accepting surfaces of the second group effective.

These small non ink-accepting surfaces of the second group are only capable of developing their lightening action in the presence of the small non ink-accepting surfaces of the first group; this is because of their area. They are too small per se. They can only become obstructed and remain obstructed under normal conditions of use. In contrast, used with the small non ink-accepting surfaces of the first group, they become active and their action (lightening) is cumulative with that (lightening) of said small non ink-accepting surfaces of said first group.

Said small non ink-accepting surfaces of the second group are distributed in a random or non random manner. Methods have been described above for minimizing or avoiding any moiré effects.

Regarding the area of said small non ink-accepting surfaces of the second group, it should initially be noted that it is not necessarily the same for all of said small non ink-accepting surfaces of said second group. In an advantageous variation, all of said small non ink-accepting surfaces of said second group have the same area, but this constitutes only one variation. On a plate of the invention, it is entirely possible to find small non ink-accepting surfaces with different areas which are not effective per se. In any event, the area(s) in question is (are) smaller than that (those) of the small non ink-accepting surfaces of the first group. It is clearly difficult to give absolute values, or even relative values, because of all of the parameters involved. However, on the surface of the plates of the invention, within the ink-accepting surfaces, there exist two types of non ink-accepting lightening surfaces: small surfaces, in the conventional sense of the term according to the disclosure in FR-A-2 660 245 and/or EP-A-0 770 228, and the smaller ones. It may be indicated that, in general, the mean area of the small non ink-accepting surfaces of the second group is less than ⅔ of the mean area of the small non ink-accepting surfaces of the first group. In an advantageous variation, the mean area of said small non ink-accepting surfaces of said second group is in the range ¼ to ⅔, advantageously in the range ¼ to ½ of the mean area of said non ink-accepting surfaces of said first group.

Said small non ink-accepting surfaces of the second group should not be too small, as then they would risk being ineffective regardless of the area(s) of the small surfaces of the first group and regardless of the context of use. In principle, they have an area of more than 100 μm². Further, there is the problem with generating them on the surface of the plate.

Said small non ink-accepting surfaces of said second group are advantageously used in a quantity sufficient to lighten the ink-accepting surface(s) concerned by 4% to 35%, advantageously 8% to 20%, by lightening.

The percentage lightening resulting from the small non ink-accepting surfaces of said first and second groups is cumulative. Thus, it has been proved possible, in a completely surprising manner, to lighten in accordance with the invention, in an advantageous manner, to percentages which according to the prior art (using a larger number of small surfaces of the first group and/or with larger area small surfaces of said first group) are highly deleterious to printing.

This is more especially the case since more lightening dots and/or larger areas can be used in the first group in certain values such as very dark values and the flat tones, and the small areas of the second group can be fewer and/or smaller in certain values, such as light values and very light values.

Incidentally, it should be recalled here that the percentage lightening of the ink-accepting surfaces of the plates of the invention is not necessarily constant; the percentage lightening due to the small non ink-accepting surfaces of the first group and/or the percentage lightening due to the small non ink-accepting surfaces of the second group is/are not necessarily constant. The advantage of lightening the dark values to a greater extent is known. Further, using small non ink-accepting surfaces of the second group allows the light values to be lightened while avoiding banding (appearance of bands) when the small lightening surfaces of the first group are only used in the other values.

In characteristic manner, then, on the surface of the plates of the invention, more precisely in the lightened ink-accepting surfaces of said surface (in only a part of them, and advantageously in all of said lightened ink-accepting surfaces), small non ink-accepting surfaces of the first group and small non ink-accepting surfaces of the second group are found. If no precautions are taken, then small surfaces resulting from partial superimposition of a small non ink-accepting surface of the first group and a small non ink-accepting surface of the second group or even perfect registration (tangential) of two of such small surfaces are unavoidably produced. This risks ruining the print by generating lightening surfaces which are too big, which may be visible on the printed support, and so care must be taken that none of said small non ink-accepting surfaces of the second group are in contact (tangential and/or with superimposition) with a small non ink-accepting surface of the first group. Precautions should be taken when preparing the plate. Software may thus be used, generating all of said small surfaces of the second group separated by at least one pixel from said small surfaces of the first group. In an advantageous variation, in the lightened ink-accepting surfaces of the plates of the invention, none of said small non ink-accepting surfaces of said second group is thus in contact with a small non ink-accepting surface of said first group.

In a further advantageous variation, each of said small non ink-accepting surfaces of said first and second groups is inside the ink-accepting surface within which it is involved.

It has been indicated above that all of said small non ink-accepting surfaces of said first group advantageously have the same area (denoted S, for example) and independently, all of said small non ink-accepting surfaces of said second group advantageously have the same area (denoted s, for example). Highly advantageously, the plates of the invention have two principal groups of small non ink-accepting surfaces: a first group, with area S and a second group, with area s; (with, in addition, small non ink-accepting surfaces with an area of more than S and a maximum of S+s).

The plates of the invention as described above, may be obtained by a variety of types of processes which are known per se. Said processes are known to generate small lightening surfaces; the recommendation of the invention is that they be used to generate at least two types of small surface of this type.

The plates of the invention can be conventionally obtained (see patent applications FR-A-2 660 245 and EP-A-0 770 228): the plate can be exposed through at least one film.

They can be obtained as discussed in International patent application WO-A-97 35233: by exposing a positive pre-sensitized web, exposure being through the opaque pierced surface of a tub; said web then being cut into plates.

Direct exposure may be carried out using imagers (computers) with beams controlled by software. The same software may allow ink-accepting surfaces corresponding to the patterns to be printed to be obtained as well as the various groups of small non ink-accepting lightening surfaces. It is also possible to use a plurality of programs. All variations are possible. Powerful programs already exist.

It is also possible to use a quite different technique, a projection technique. Either the ink-accepting solution or a solution which can eliminate surfaces and small surfaces of an ink-accepting varnish previously deposited on the plate is projected onto the plate using spray nozzles. This latter variation of the projection technique is described in patent application FR-A-2 843 558.

It should be noted that the plate preparation processes of the invention are illustrative; advances in information technology will render them easier and easier to implement.

The key to the invention—the joint use of different groups of non ink-accepting surfaces to lighten the non ink-accepting surfaces—is entirely innovative and produces unexpected, advantageous results. We shall return to this point below in the present text.

In its final aspect, the present invention concerns a wet offset printing process. Said process is a conventional process in that it comprises the following steps in succession:
copying a plate, generating ink-accepting surfaces on the surface of said plate corresponding to the patterns to be printed and including small non ink-accepting lightening surfaces;
fixing said copied plate to a plate cylinder;
wetting then inking said fixed copied plate or inking it directly with an ink based on an ink/water mixture; and
transferring the ink held on said lightened ink-accepting surfaces onto the blanket then onto the substrate to be printed in succession.

This process is described in patent applications FR-A-2 660 245 and EP-A-0 770 228, wherein the copy of the plate includes introducing small non ink-accepting lightening surfaces into the ink-accepting surfaces.

The process of the invention is original in that the lightened plate is a plate as described above. In characteristic manner, the copying step includes creating the two groups of small non ink-accepting surfaces in the ink-accepting surfaces.

The advantage of the present invention will be summarized below.

The improved lightening of the invention has proved effective on practically all papers, with all presses, screens and inks whatever the size and distribution of the ink-accepting surfaces over the plate.

Said improved lightening provides improved advantages as regards lightening (as listed in particular in EP-A-0 770 228). More particularly, emphasis can be placed on the excellent print quality, better productivity, and savings as regards supplies and energy.

In particular, ink and paper consumption are reduced.

Drying of the deposited ink is improved (due to the better homogeneity of the ink/water mixture and the thinner deposit of said mixture).

The print quality is improved, even more so when it is used under average conditions or even poor conditions.

Further, the specific lightening of the invention does not actually weaken the plates. It can be shown that by rendering the ink-water mixture more balanced on the surface of said plates and thus by also reducing the tack of the ink, the service life of said plates is increased by more than 60%. Said plates are no longer subjected to stresses which are as severe as those in the prior art (deposits on the blankets which are primarily responsible for wear of the plates having also been substantially reduced).

Finally, the plates of the invention allow fluid ink to be used on a more industrial basis.

The invention will now be illustrated in a non limiting manner in the following examples.

The plates used in Examples 1 to 6 were positive Thermostar 830 nm thermal plates from Agfa:
785×1030×30/100 for a Roland sheet-fed press;
708×1020×30/100 cut in the middle (i.e. 708×510×30/100) for a Heidelberg Web 8 web press.

The plates were exposed with beams of an Xcalibur G.L.V. Print Drive, Double Burn imager from Agfa, developed, rinsed, gummed then dried. The stochastic screens were from Esko-Graphics; the inks were from Sun Chemical.

### EXAMPLE 1

A plate was copied using two software packages.

The first created small non ink-accepting lightening surfaces of about 896 μm² the number of which represented about 6% of the ink-accepting area of the plate, and other small non ink-accepting lightening surfaces of about 448 μm² and representing 12% of the same ink-accepting surface.

All of these small non ink-accepting lightening surfaces were distributed using the random frequency modulation technique and did not touch each other.

The ink-accepting surface was thus lightened by 6%+12%, i.e. 18%.

The second program created texts and a 100 screen reproduction with the 98% white dot having an area of about 1290 μm².

The plate was fixed to a web press with a dryer and printing was carried out without wetting onto a matt paper using fluid ink (Washington Post Single Fluid Black) from Sun Chemical, which contained about 20% by weight of water.

The print was good and 3000 sheets were printed without particular problems, with the wasted paper on startup limited to a few sheets.

### EXAMPLE 2

The procedure of Example 1 was followed, employing wetting of the press and a soft ink (Solar® from Sun Chemical).

The print was good, but it used more paper because of the adjustment required to the wetting step.

### EXAMPLE 2BIS

The procedure of Example 2 was followed, but the 18% lightening was achieved with only 896 μm² small non ink-accepting surfaces.

Adjusting the wetting was more difficult and the print quality was poorer.

### EXAMPLE 3

A plate was copied using a program to generate on its surface small non ink-accepting lightening surfaces of about 672 μm² (larger area than the area of about 573 μm² of a 98% screen white dot of the 150 screen), their number representing about 8% of the ink-accepting surface, and other non ink-accepting small lightening surfaces of about 336 μm², their number representing about 8% of the same ink-accepting surface.

They were distributed using the random frequency modulation technique, they did not touch and they represented a total area of 8%+8%, i.e. 16%.

Using the “double burn” technique, another program with text and 150 screen reproductions was copied onto the plate.

The copied recto-verso plate was cut in the middle and the recto plate and the verso plate were fixed to the web press.

The ink used was a hard ink (Maury LWC® from Sun Chemical).

The print was of high quality and the paper readily left the blankets because of the reduced tack of the ink.

However, the speed of the ink rollers could not be adjusted to a lower value.

### EXAMPLE 3BIS

The procedure of Example 3 was followed, but with a lightening of 16% obtained solely with small surfaces of 672 μm².

On printing, the screened reproductions were of poorer quality and the speed of the ink rollers had to be increased to obtain values which satisfied the client.

### EXAMPLE 4

Software generated small non ink-accepting lightening surfaces of about 560 μm² (area close to the 573 μm² of a 98% white dot of a 150 screen), their number representing about 8% of the ink-accepting surface of the plate; and small non ink-accepting lightening surfaces of about 224 μm², which represented about 8% of the same ink-accepting surface.

Said small surfaces were all distributed using the random frequency modulation technique and did not touch each other.

Hence, the lightened area was 8%+8%, i.e. 16%.

A further program representing texts and screen reproductions (150 screen) was copied in a double burn with the lightening program.

The ink used was a hard ink (Maury LWC® from Sun Chemical).

On the web press, printing was high quality, the paper readily left the blanket because of the reduced tack of the ink, and the speed of the ink rollers was reduced significantly, which also facilitated drying.

### EXAMPLE 5

A program containing texts and reproductions in black (a single color) made with a Monet frequency modulation (stochastic) screen from Esko-Graphics with dots with an area of about 672 μm² was used for reproductions. It was copied at the same time (double burn) as another lightening program.

This contained small non ink-accepting lightening surfaces having firstly an area of 448 μm², their number representing 6% of the ink-accepting surface and secondly having an area of 224 μm², their number representing 8% of the same ink-accepting surface, i.e. 6%+8%=14% of the lightened ink-accepting surface.

All of the small non ink-accepting lightening surfaces were distributed using the random frequency modulation technique and did not touch each other.

The agglomerates of said stochastic screen were thus cut through by the small lightening surfaces and the impression was of excellent quality without encountering the difficulties often encountered with a press with stochastic screens.

### EXAMPLE 6

The same software was used for the black reproductions and text as in Example 5.

However, lightening was carried out firstly with 6% of small non ink-accepting surfaces with an area of 448 μm² and secondly with 8% of small non ink-accepting surfaces with an area of 224 μm².

All of the small lightening surfaces were used in a screen ruling comparable to the screen ruling of a conventional screen, they did not touch each other and they were placed at an orientation of 45 °.

The results were comparable with the results of Example 5.

1. A plate for use in wet offset printing, comprising at its surface ink-accepting surfaces corresponding to patterns to be printed; at least part of said ink-accepting surfaces being lightened, i.e. including small non ink-accepting lightening surfaces, characterized in that over at least part of said lightened ink-accepting surfaces, said small non ink-accepting lightening surfaces are distributed in at least two groups:
a first group of small non ink-accepting surfaces with an area (areas) sufficient to be effective per se and in a quantity sufficient to lighten the ink-accepting surface(s) involved in lightening by at least 4%; and
a second group of small non ink-accepting surfaces, not effective per se because their area(s) is (are) too small; the mean area of said small non ink-accepting surfaces of said second group in general being less than ⅔ of the mean area of said small non ink-accepting surfaces of said first group; said small non ink-accepting surfaces of said first and second groups being distributed so as to minimize, advantageously avoid, any moiré effects.

2. The plate according to claim 1, characterized in that said small non ink-accepting surfaces of said first and/or second groups are distributed in a random manner or in conventional screens and, for each color, in the orientation employed for the screen for said color.

3. The plate according to claim 1, characterized in that when printing patterns with a stochastic screen, the small non ink-accepting surfaces of said first and second groups distributed in a (several) conventional screen(s) are orientated for each color in the orientation normally used for printing said color.

4. The plate according to claim 1, characterized in that the mean area of said small non ink-accepting surfaces of said second group is in the range ¼ to ⅔, advantageously in the range ¼ to ½ of the mean area of said small non ink-accepting surfaces of said first group.

5. The plate according to claim 1, characterized in that:
when printing patterns with an amplitude modulation screen, the area(s) of said small non ink-accepting surfaces of said first group remains (remain) smaller than the 95% white dot value, and advantageously smaller than the 98% white dot value of said screen; or
when printing patterns with a stochastic screen, the area(s) of said small non ink-accepting surfaces of said first group is (are) always less than three times the area of the dot of said screen, and generally in the range 0.5 times to 2 times said area.

6. The plate according to claim 1, characterized in that said small non ink-accepting surfaces of said first group are present in a quantity sufficient to lighten the ink-accepting surface(s) concerned with lightening by 4% to 20%, advantageously by 6% to 12%.

7. The plate according to claim 1, characterized in that said small non ink-accepting surfaces of said second group are present in a quantity sufficient to lighten the ink-accepting surface(s) concerned with lightening by 4% to 35%, advantageously by 8% to 20%.

8. The plate according to claim 1, characterized in that the percentage lightening of its ink-accepting surfaces is not constant.

9. The plate according to claim 1, characterized in that none of said small non ink-accepting surfaces of said second group is in contact with a small non ink-accepting surface of said first group.

10. The plate according to claim 1, characterized in that each of said small non ink-accepting surfaces of said first and second groups is inside the ink-accepting surface within which it is present.

11. The plate according to claim 1, characterized in that said small non ink-accepting surfaces of said first group have the same area and/or, advantageously and, said small non ink-accepting surfaces of said second group have the same area.

12. A process for preparing a plate according to claim 1, characterized in that it comprises copying said plate to generate the ink-accepting surfaces corresponding to the patterns to be printed on the surface of said plate as well as said small non ink-accepting lightening surfaces within said ink-accepting surfaces; said small non ink-accepting surfaces being copied:
by a technique for exposing said plate through at least one film and/or a technique for exposing a precursor web of positive pre-sensitized plates through the opaque wall of a tube; and/or
by a technique for directly exposing said plate with beams controlled by software; and/or
by a projection technique.

13. A wet offset printing process, comprising:
copying a plate, generating ink-accepting surfaces on the surface of said plate corresponding to the patterns to be printed and including small non ink-accepting lightening surfaces;
fixing said copied plate to a plate cylinder;
wetting then inking said fixed copied plate or inking it directly with an ink based on an ink/water mixture; and
transferring the ink held on said lightened ink-accepting surfaces onto the blanket then onto the substrate to be printed in succession;
characterized in that the copy of said plate generates a plate according to claim 1.
